(19) United States
(12) Patent Application Publication
(10) Pub. No.: US 2004/0258179 A1
(43) Pub. Date: Dec. 23, 2004

(54) RF receiver and method for region specific data selection

(76) Inventors: Jerral A. Long, Kokomo (IN); J. Robert Dockemeyer JR., Kokomo (IN); Glenn A. Walker, Greentown (IN)

Correspondence Address: DELPHI TECHNOLOGIES, INC., M/C 480-410-202, PO BOX 5052, TROY, MI, 48007, US

(21) Appl. No.: 10/601,152

(22) Filed: Jun. 20, 2003

(51) Int. Cl. H04L 27/06

(52) U.S. Cl. 375/316

(57) ABSTRACT

A digital RF receiver and method for providing regional data to a user acquired from a large geographic data broadcast. The RF receiver receives an RF signal containing a stream of broadcast data. The stream of broadcast data includes primary data and more geographically limited regional data. The receiver includes a device for selecting a user specific region, and a decoder for acquiring the regional data. The receiver further includes a data processor for processing the regional data and the selected user specific region to obtain regional data designated for the user specific region, and an output for outputting the regional data pertaining to the selected user specific region.

### TECHNICAL FIELD

The present invention generally relates to radio frequency (RF) receivers and, more particularly, to an RF receiver and method of providing geographic region specific data to a user.

### BACKGROUND OF THE INVENTION

Automotive vehicles are commonly equipped with audio radios for receiving broadcast radio frequency (RF) signals, processing the RF signals, and broadcasting audio information to passengers in the vehicle. More recently, satellite digital audio radio (SDAR) services have become available that offer digital radio service covering a large geographic area, such as North America. Currently, a couple of satellite based digital audio radio services are available in North America, which generally employ either geo-stationary orbit satellites or highly elliptical orbit satellites that receive uplinked programming which, in turn, is rebroadcast directly to digital radios in vehicles on the ground that subscribe to the service. Each vehicle subscribing to the digital service generally includes a digital radio having a receiver and one or more antennas for receiving the digital broadcast.

The radio receivers are programmed to receive and decode the digital data signals, which typically include many channels of digital audio. In addition to broadcasting the encoded digital quality audio signals, the satellite based digital audio radio service may also transmit data that may be used for various applications. The broadcast signal may also include other information for reasons such as advertising, informing the driver of warranty issues, providing information about the broadcast audio information, and providing news, sports, and entertainment broadcasting. Accordingly, the digital broadcast may be employed for any of a number of satellite audio radio, satellite television, satellite Internet, and various other consumer services.

In current satellite based digital audio radio services, the same data stream is generally broadcast to all users of the service over a large geographic area covering multiple cities, states and countries. With the adoption of the consumer services broadcast, the ability to acquire local regional information such as local news, weather, traffic information and other local or regional information is generally not available. With large coverage services, the transmission of regional information is impractical because of the large number of possible regions within the broadcast coverage area and the lack of interest for users to hear or otherwise receive regional information for geographic regions outside of their own region of interest.

Accordingly, it is therefore desirable to provide for an RF receiver that can receive primary data designated for a broad geographic coverage region and also provide more geographically limited regional data to a user. In particular, it is desirable to provide for a radio receiver that may receive local information such as local news, weather, and traffic information that is specific to the end user's region of interest.

### SUMMARY OF THE INVENTION

In accordance with the teachings of the present invention, a digital RF receiver and method are provided for providing to a user regional data acquired from a data broadcast distributed over a large geographic area. The RF receiver includes an input for receiving an RF signal containing a stream of broadcast data. The stream of broadcast data includes primary data and regional data. The primary data is intended to be distributed over a broadcast area, and the regional data is specific to a select geographic region of the broadcast area. The receiver also includes a device for selecting a user specific region, and a decoder for acquiring the regional data from the stream of broadcast data. The receiver further includes a data processor for processing the regional data and the selected user specific region to obtain regional data designated for the selected user specific region, and an output for outputting the regional data pertaining to the selected user specific region. The RF receiver is thereby able to acquire and output regional information broadcast over a large geographic area.

These and other features, advantages and objects of the present invention will be further understood and appreciated by those skilled in the art by reference to the following specification, claims and appended drawings.

### BRIEF DESCRIPTION OF THE DRAWINGS

The present invention will now be described, by way of example, with reference to the accompanying drawings, in which:

FIG. 1 is a block diagram illustrating a digital RF receiver for processing broadcast data containing primary and local geographic data according to the present invention;

FIG. 2 is a block diagram illustrating a stream of broadcast data including both primary and periodic regional data;

FIG. 3 is a block diagram further illustrating the regional data within the stream of broadcast data;

FIG. 4 is a block diagram further illustrating regional data interleaved within the stream of broadcast data;

FIG. 5 is a block diagram further illustrating the regional data;

FIG. 6 is a flow diagram illustrating a user input routine for entering a user specific region according to one embodiment; and

FIGS. 7A and 7B is a flow diagram illustrating a routine for acquiring regional information pertaining to the user selected region according to the present invention.

### DESCRIPTION OF THE PREFERRED EMBODIMENT

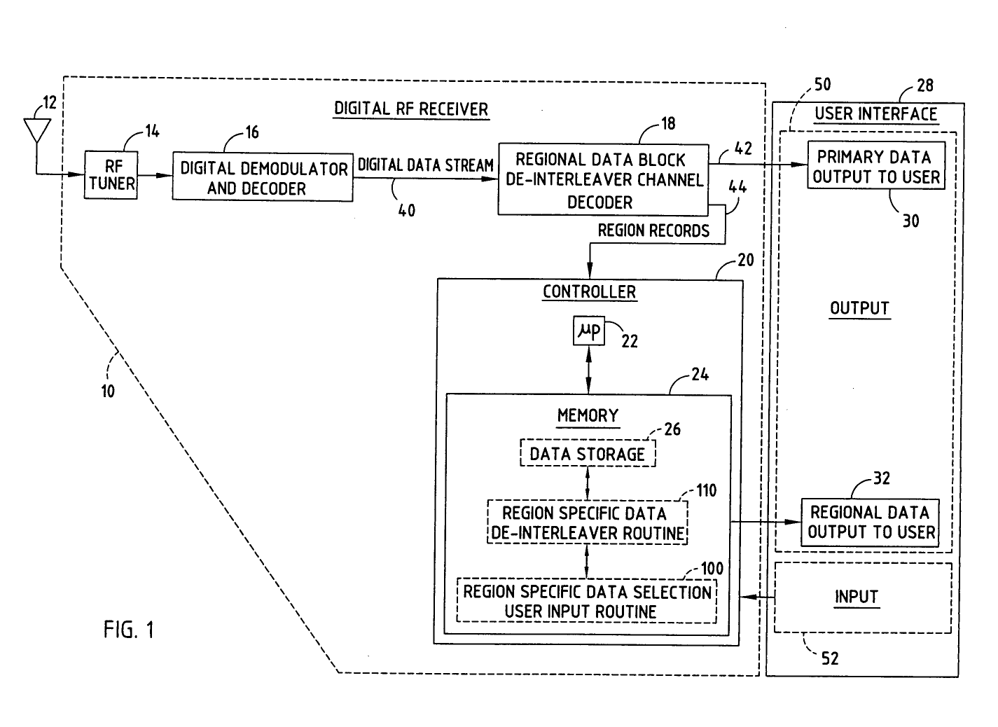

Referring to FIG. 1, a digital RF receiver 10 is illustrated for receiving RF signal broadcasts containing a stream of broadcast data. According to one embodiment, the RF signal broadcasts may be transmitted according to a satellite based digital audio radio service (SDAR) for providing any of a number of consumer services including radio, television, internet, and other data broadcast services. The RF signal broadcast may otherwise be transmitted via terrestrial or other satellite-based RF broadcast services. The digital RF receiver 10 is well suited to be employed on a vehicle that is mobile and may travel throughout multiple regions within a large geographic area.

The digital RF receiver 10 has an input for receiving an RF signal containing a stream of broadcast data. The input may include an antenna 12 for receiving satellite or terrestrial based broadcast signals. The digital RF receiver 10 also communicates with a user interface 28 having one or more outputs, such as output 50, and one or more inputs, such as input 52. Output 50 may include an audio output device (e.g., speaker), a visual output device (e.g., display) or other output device(s). Input 52 may include a voice recognition input device, a keypad, or other user inputs.

The digital RF receiver 10 is configured to receive and process digital data signals received by the input antenna 12. The digital radio receiver 10 includes an RF tuner 14 receiving as an input the RF signals received by the antenna 12. The RF tuner 14 selects a frequency bandwidth of digital audio and/or other data to pass RF signals within a tuned frequency bandwidth. The digital radio receiver 10 also includes a digital demodulator and decoder for extracting the time division multiplexed (TDM) digital data stream 40. The digital data stream 40 includes primary data generally intended for broadcast and distribution over a wide geographic broadcast area and regional data that is intended to be a distributed in a more limited geographic size local region within the broadcast area. The regional data is processed as described herein in accordance with the present invention.

The digital RF receiver 10 includes a regional data block de-interleaver channel decoder 18 that decodes the digital data stream 40 to determine and separate the primary data intended for wide geographic use from the regional data intended for regional use. The channel decoder 18 outputs primary data 42 shown in block 30 to an output 50 of the user interface 28. The primary data 42 may then be presented to the user via any of a number of outputs such as audio and/or visual outputs. The channel decoder 18 also outputs regional records 44 containing the regional data that is specific to predetermined geographic regions. The regional records 44 are input to a controller 20 which processes the regional records as described herein.

The controller 20 includes a microprocessor 22 and memory 24. The microprocessor 22 may include a conventional microprocessor having the capability for processing algorithms and data as described herein. The memory 24 may include read-only memory (ROM), random access memory (RAM), flash memory, and other commercially available volatile and non-volatile memory devices. Stored within memory 24 and accessed/processed by microprocessor 22 is data storage 26, region specific data selection user input routine 100, and region specific data de-interleaver routine 110.

The region specific data selection user input routine 100 captures a user selected input of a specific region and stores the user selected input region in memory. The user input data may include any of a number of region identifiers including a name or identification (e.g., alphanumeric code) for a city, county, state, zip code, highway name/number, or other regional identifiers. The user input selection of the specific region may be achieved by use of a keypad input, a menu selection, voice recognition, or other available input devices. The region specific data de-interleaver routine 110 processes the regional data, obtains regional data for the user selected region, and compiles the regional data to form a completed message so that it may be output to a user as regional data 32.

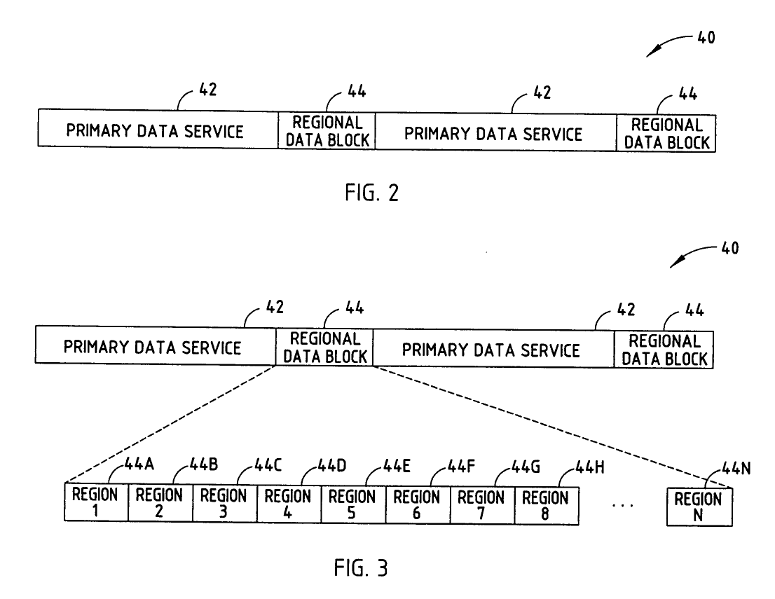

A time serially transmitted stream of data 40 is illustrated in FIGS. 2-5 containing primary data service 42 and periodically transmitted regional data blocks 44. The primary data service 42 generally contains data intended for distribution to users over a wide geographic broadcast area. The primary data service 42 may include various forms of data such as audio (e.g., music), video images, Internet data, or other consumer oriented data. The primary data service 42 is intended to cover a broad geographic region without containing significant amounts of regionally specific data.

The regional data 44 is shown periodically transmitted blocks of data embedded within the primary data service stream 40. The regional data blocks 44 may include various forms of data such as audio (e.g., music), video, Internet data, or other consumer oriented data that generally pertains to one or more geographic regions within the broadcast. By periodically transmitting the regional data blocks 44 between blocks of primary data service 42, the regional data blocks 44 may be broadcast with little or no delay in the transmission of the primary data service 42.

As shown in FIG. 3, each regional data block 44 is divided into a series of regionally specific records 44A-44N. The region specific records 44A-44N each contains regional information relevant to a predetermined geographic region. The region specific records 44A-44N contain an identifier identifying the predetermined region. Each of region records 44A-44N could be of fixed length, or the regional data block 44 may contain a preamble identifying the number of subsequent records and the length of each regional record.

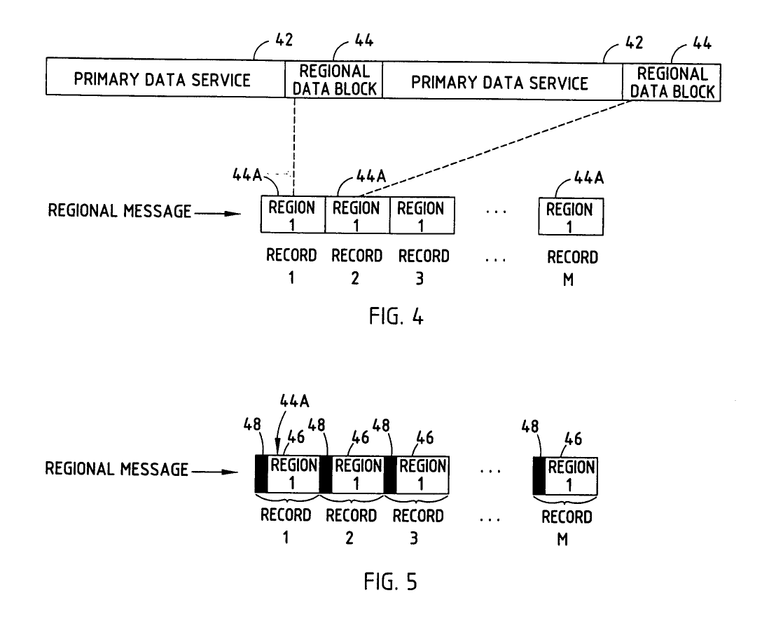

Referring to FIG. 4, record 44A pertaining to a specific geographic region are shown buffered and concatenated to form a complete regional message for its intended geographic region. That is region 1 which is provided in region specific record 44A may include data acquired from a series of regional data blocks 44 which, over a period of time, is acquired and compiled to form the complete regional data message. It should be appreciated that each of regions 44A-44N may likewise be buffered and concatenated to form separate complete messages for each geographic region of interest.

Referring to FIG. 5, regional data message 44A is further shown containing a regional identifier 48 and a data block 46. The regional identifier 48 may be stored in a record preamble and may include any of a number of geographic region identifiers including a name or code (e.g., alphanumeric code) for a city, county, state, zip code, highway name/number, or other identifiers that associate the information in data block 46 with a specific geographic region. The regional identifier 48 is compared with the user selected input to determine if the user has selected this regional data.

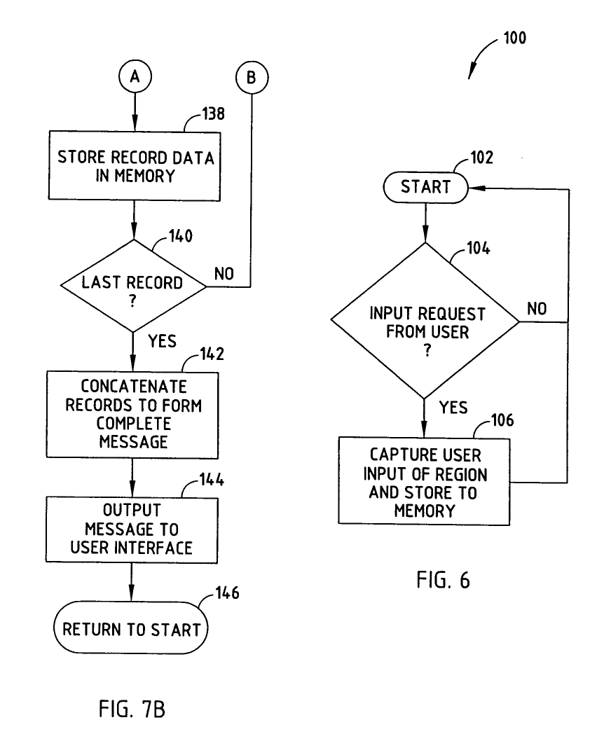

The region specific data selection user input routine 100 is shown in FIG. 6 for capturing and storing the user entered regional input into memory. Routine 100 begins at step 102 and checks for an input request from a user in decision step 104. According to one embodiment, the input request from the user may include entry of a regional identifier by a user. If an input request has been received from a user, routine 100 proceeds to step 106 to capture the selected user input region and stores the selected region in memory. Otherwise, routine 100 continues to check for a region input request from the user.

According to another embodiment, the user input may include an automatically generated local geographic region of interest. This may be accomplished by employing a position determining device, such as a global positioning system (GPS) receiver, to determine the current position of the receiver/user. Given the current position (e.g., latitude and longitude coordinates) of the receiver/user, a local regional coverage zone may be identified and used as the selected region input.

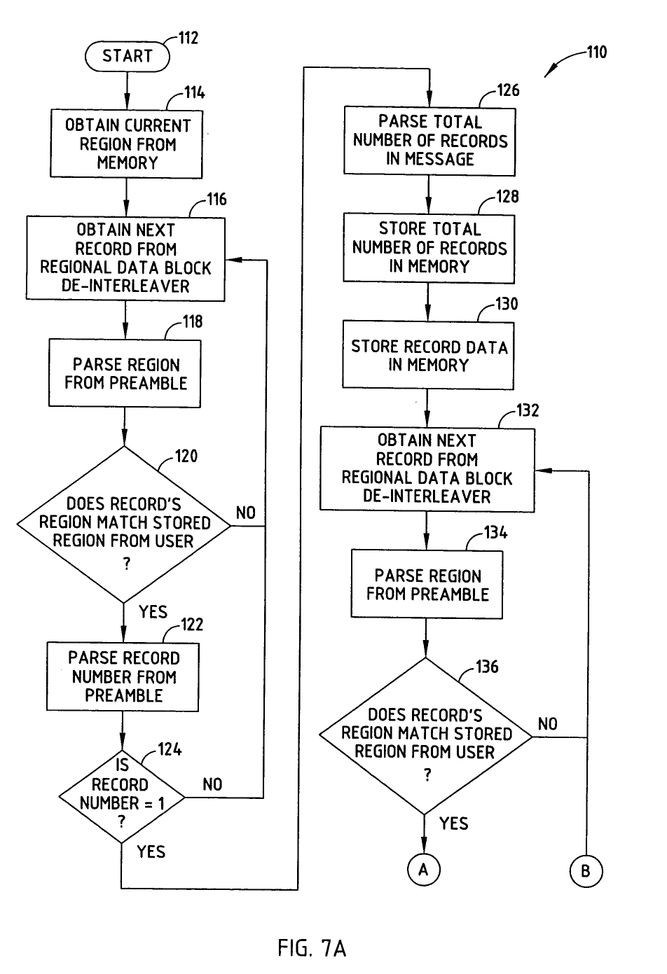

Referring to FIGS. 7A and 7B, the region specific data de-interleaver routine 110 is shown beginning at step 112. In step 114, routine 110 obtains the current user selected region stored in memory. The current region stored in memory is generated by user input routine 100. Proceeding to step 116, the next regional record from the regional data block de-interleaver is obtained. The region identification associated with this regional record is parsed from the record preamble in step 118. Next, in decision step 120, routine 110 determines if the region record matches the stored region selected by the user and, if not, returns to step 116 to obtain the next record. If the region record matches the stored region selected by the user, routine 110 proceeds to step 122 to parse the record number from the preamble.

Proceeding to decision step 124, routine 110 determines if the record number is equal to one and, if not, returns to step 116 to obtain the next record. If the record number is equal to one, as determined in decision step 124, routine 110 proceeds to step 126 to parse the total number of records in the message. The total number of records are then stored in memory in step 128. The record data is also stored in memory in step 130.

Proceeding to step 132, routine 110 obtains the next record from the regional data block de-interleaver. Routine 110 then parses the region from the record preamble in step 134. In decision step 136, routine 110 checks whether the region record matches the stored region selected by the user and, if not, returns to step 132 to obtain the next record. If the region record matches the stored region selected by the user, routine 110 proceeds to store the record data in memory in step 138. Routine 110 then proceeds to decision step 140 to determine if the record data is the last record and, if not, returns back to step 132 to obtain the next record. If the record data is the last record, routine 110 proceeds to concatenate the records to form a complete regional message in step 142. The regional message is then output to the user interface in step 144 so that it may be presented as an output to a user via an output device. Thereafter, routine 110 returns to the beginning by way of step 146.

Accordingly, the RF receiver of the present invention advantageously provides primary information intended for a wide area broadcast and the ability to provide more geographically limited regional data to a user. Thus, both wide area and local area data can be broadcast via a single service and processed by a single receiver. It should be appreciated that a user may utilize the present invention to receive local news, weather, traffic, and other information from a larger national broadcast without being subjected to regional data in regions outside of the region of interest.

It will be understood by those who practice the invention and those skilled in the art, that various modifications and improvements may be made to the invention without departing from the spirit of the disclosed concept. The scope of protection afforded is to be determined by the claims and by the breadth of interpretation allowed by law.

1. An RF receiver comprising:
an input for receiving an RF signal containing a stream of broadcast data, said stream of broadcast data including primary data and regional data, wherein the primary data is intended to be distributed over a broadcast area and the regional data is specific to a select geographic region of the broadcast area;
a device for selecting a user specific region;
a decoder for acquiring the regional data from the stream of broadcast data;
a data processor for processing the regional data and the selected user specific region to obtain regional data designated for the selected user specific region; and
an output for outputting the regional data pertaining to the selected user specific region.

2. The receiver as defined in claim 1, wherein the device for selecting the user specific region comprises a user interface input.

3. The receiver as defined in claim 1, wherein the RF broadcast data comprises digital data.

4. The receiver as defined claim 3, wherein the RF receiver comprises a digital radio receiver.

5. The RF receiver as defined in claim 1, wherein the receiver is employed on a vehicle.

6. The receiver as defined in claim 1, wherein the data processor processes a block of regional data having a region identifier and compares the selected user specific region to the region identifier to determine if the block of regional data pertains to the selected user specific region.

7. The receiver as defined in claim 1, wherein the data processor performs a de-interleaving routine to compile regional data pertaining to the selected user specific region.

8. The receiver as defined in claim 7, wherein the de-interleaving routine compiles regional data from a plurality of blocks of regional data within the stream of broadcast data.

9. The receiver as defined in claim 1, wherein the input comprises an antenna.

10. A method of providing regional data from a stream of broadcast data to a user via an RF receiver, said method comprising the steps of:
receiving an RF signal containing a stream of broadcast data, said stream of broadcast data including primary data and regional data, wherein the primary data is intended to be distributed over a broadcast area and the regional data is specific to a select geographic region of the broadcast area;
receiving a selection of a user specific region;
acquiring the regional data from the stream of broadcast data;
processing the regional data and the selected user specific region to obtain regional data designated for the selected user specific region; and
providing the regional data pertaining to the selected user specific region as an output.

11. The method as defined in claim 10, wherein the step of receiving an RF signal comprises receiving digital data.

12. The receiver as defined in claim 10, wherein the user specific region is selected by a user entering the user specific region with a user interface input.

13. The method as defined in claim 10, wherein the step of processing the regional data comprises processing a block of regional data having a region identifier and comparing the selected user specific region to the region identifier to determine if the block of regional data pertains to the selected user specific region.

14. The method as defined in claim 10, further comprising the step of compiling data pertaining to the selected user specific region.

15. The method as defined in claim 10, wherein the step of compiling comprises acquiring a plurality of blocks of regional data and concatenating the plurality of blocks of regional data to form a regional data message.

16. The method as defined in claim 10, wherein the broadcast data comprises audio radio data.

17. The method as defined in claim 16, wherein the method is performed on a digital radio receiver.

18. The method as defined in claim 10, wherein the receiver is located on a vehicle.
